(19) United States
(12) Patent Application Publication
(10) Pub. No.: US 2009/0010258 A1
(43) Pub. Date: Jan. 8, 2009

(54) PACKET PRIORITIZATION IN AD HOC NETWORKS

(75) Inventors: RAMY S. AYOUB, ARLINGTON HEIGHTS, IL (US); MARIO F. DERANGO, CARY, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/773,040

(22) Filed: Jul. 3, 2007

(51) Int. Cl. H04L 12/56

(52) U.S. Cl. 370/392

(57) ABSTRACT

A wireless communication device operable as a node in an ad hoc network (100), the device including a controller communicably coupled to a transceiver, wherein the controller is configured to determine priority of a packet received by the transceiver for forwarding to another node in the ad hoc network. The controller is also configured to establish a priority link in the ad hoc network if the priority of the packet satisfies a priority condition, and to cause the transceiver to transmit the received packet on the priority link if the priority condition is satisfied. In one application, the high priority packets are originated by a public safety official communicating in a mesh network.

The present disclosure relates generally to wireless communications in ad hoc networks, and more particularly to prioritizing traffic and particularly packets communicated within ad hoc networks comprising nodes formed by communication devices, for example, cognitive radio devices.

### BACKGROUND

In the near future, the demand for wireless communication services is projected to exceed that which may be accommodated by the available spectrum currently allocated for existing communication systems. Governmental agencies including the Federal Communications Commission (FCC) responsible for allocating radio spectrum have encouraged the implementation of cognitive radio technology to more efficiently utilize the finite electromagnetic spectrum available for wireless communications. The concept behind cognitive radio technology is to dynamically utilize available portions of spectrum allocated for cognitive usage. The FCC, for example, has proposed designating the television white space spectrum for cognitive radio applications.

Ad hoc networks employing cognitively radio technology may potentially satisfy at least some of growing demand for wireless communication services. An ad hoc network is a collection of communication devices that self-organize to form a cooperative communications network. In ad hoc networks, generally, each device, also referred to as a node, has the ability to function as a source of information, a destination for information, and as a relay that forwards information to other nodes or destinations during a communication session. An autonomous ad hoc network is capable of operating without fixed infrastructure, wherein each device functions as an intermediate router to facilitate multiple communication paths thereby extending the transmission range of a communication session through multiple hops. A mesh ad hoc network provides wireless connectivity for fixed infrastructure elements with a gateway interface to one or more wide area networks. Mesh ad hoc networks feature multiple communication paths between elements that may include one or more hops. The fixed infrastructure of mesh ad hoc networks may provide wired or wireless backhaul between elements. A hybrid mesh ad hoc network comprises stationary and mobile devices, fixed infrastructure elements and gateway interfaces. The infrastructure may provide wired or wireless backhaul between ad hoc devices or autonomous ad hoc networks. Hybrid mesh ad hoc networks support networking via single or multiple hops with fixed infrastructure and/or ad hoc capable device connections.

Cognitive radio devices must be able to identify unused spectrum and then coordinate with each other to establish communications on commonly available portions of the spectrum. Ad hoc networks that employ special routing protocols and procedures, for example, mesh ad hoc networks, are particularly suitable for this coordination task. The dynamic nature of spectrum availability in a cognitive environment and the requirement to rapidly adapt to those changes mimics the routing updates that occur in mesh ad hoc networks due to the mobility of some or all of the ad hoc devices. To provide a viable alternative to existing communication networks for at least some applications, however, cognitive radios must provide mechanisms to prioritize and route communications throughout the network.

The various aspects, features and advantages of the disclosure will become more fully apparent to those having ordinary skill in the art upon a careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates an ad hoc network.

FIG. 2 illustrates a wireless communication device capable of functioning as a node in an ad hoc network.

FIG. 3 is a process flow diagram.

FIG. 4 is another process diagram.

### DETAILED DESCRIPTION

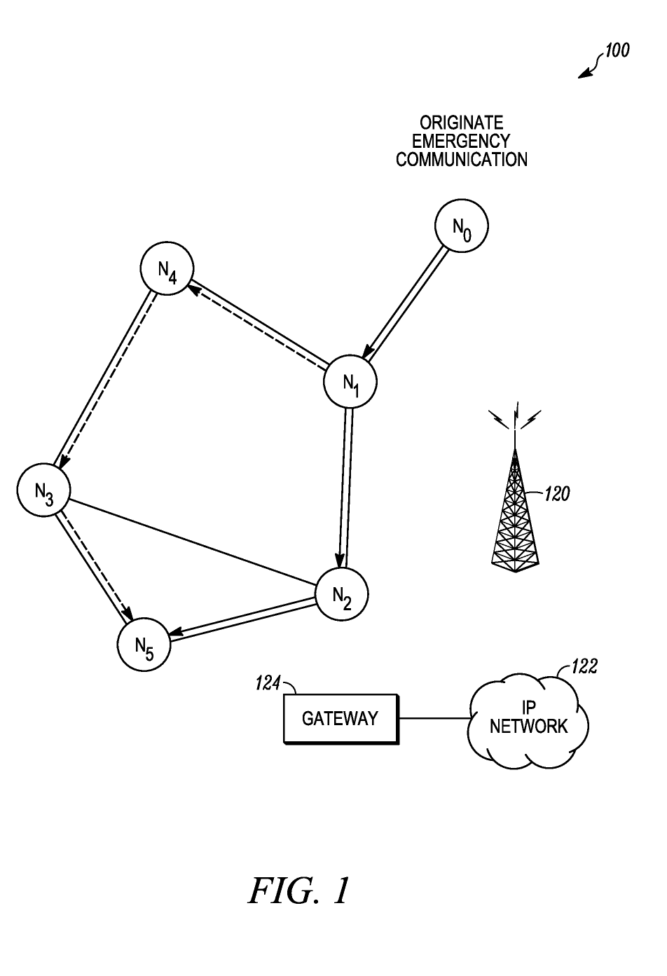

FIG. 1 illustrates a plurality of wireless communication devices capable of self-organizing to form an ad hoc communications network 100. In the ad hoc network, each wireless communication device constitutes a node of the network. In FIG. 1, the network includes nodes N₀₋₅. Generally, each node is capable of functioning as the originator of a communication, e.g., the source of information, as a destination for the communication or information, or as a relay that forwards a communication of information to one or more other nodes or destinations during a communication session. A node that relays information is also referred to as a switching node.

In some embodiments, the ad hoc network is an autonomous network capable of operating without fixed infrastructure, wherein each device functions as an intermediate router, or switching node, to facilitate multiple communication paths thereby extending the transmission range of a communication session through multiple hops. In FIG. 1, for example, the nodes N₀₋₅ may self organize with or without other nodes to form an autonomous ad hoc network. In another embodiment, the ad hoc network is a mesh network that provides connectivity for fixed infrastructure elements with a gateway interface to one or more other networks including local and wide area networks. In FIG. 1, for example, the nodes N₀₋₅ may self organize to form an autonomous ad hoc network capable of communicating with a fixed node 120 that communications with IP network 122 via a gateway 124. The disclosure is not intended to be limited to the particular network configurations illustrated as other network configurations are also contemplated, including but not limited to hybrid mesh ad hoc networks that support networking via single or multiple hops with fixed infrastructure entities and/or ad hoc capable device connections, among others.

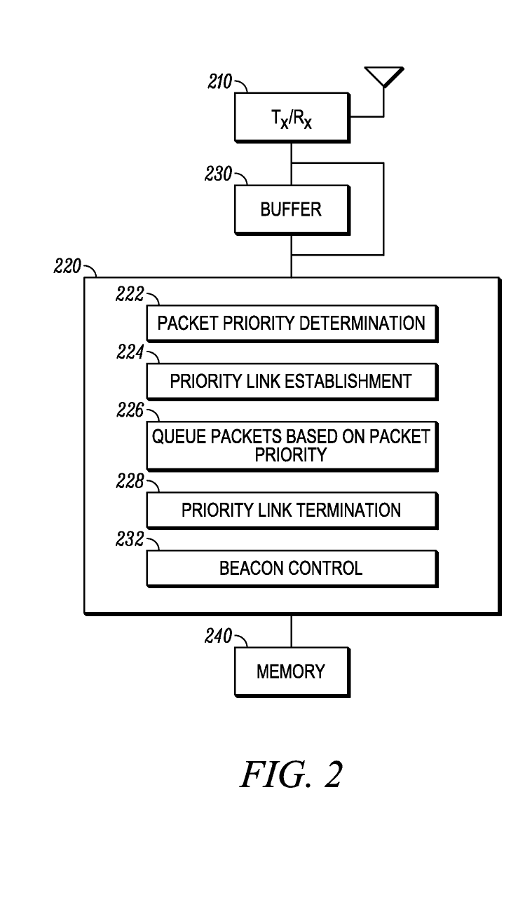

FIG. 2 illustrates a wireless communication device 200 capable of operating as a node in an ad hoc network, including those discussed above among others. Generally, the device may be a fixed base or mobile communications device. In one embodiment, the wireless communication device is a cellular communication handset, for example, a 3GPP or 3GPP2 compliant device, a WiMAX communications device, an 802.1x or other WAN or LAN capable communications device. The device may also be embodied as a wireless or wire-line base unit. Generally, the communication devices constituting the network nodes may also be compliant with a combination of these and other open and proprietary communication protocols.

In one particular implementation, the wireless communication device is a cognitive device capable of identifying unused spectrum allocated for cognitive radio usage and capable of coordinating with other cognitive devices to establish communications on commonly available portions of the allocated spectrum. The term “radio” as used in this disclosure includes all portions of the electromagnetic spectrum over which wireless communications may be implemented including but not limited to radio, infrared, microwaves among other portions of the spectrum.

In FIG. 2, the device generally comprises a transceiver 210 communicably coupled to a controller 220 and to a data buffer 230. In another embodiment, more generally, the device comprises a plurality of transceivers coupled to a controller, wherein each transceiver is coupled to a data buffer. The controller, transceiver and buffer are interconnected via control, address and data channels or buses where appropriate. These entities may be integrated in whole or in part, for example, on a common semiconductor substrate. Alternatively, these entities may be embodied as discrete elements or devices. In some embodiments, the communication device, for example, a wireless communication device handset or a portable communication device also includes a user interface. A typical user interface may include audio inputs and outputs, a display interface, a keypad or touch-screen for inputting data or other information and controlling various functions and features typically integrated on a communication device used as a network node. These and other user interface elements are not illustrated but are known generally by those of ordinary skill in the art. Some nodes, for example, some fixed base nodes, may not include a user interface.

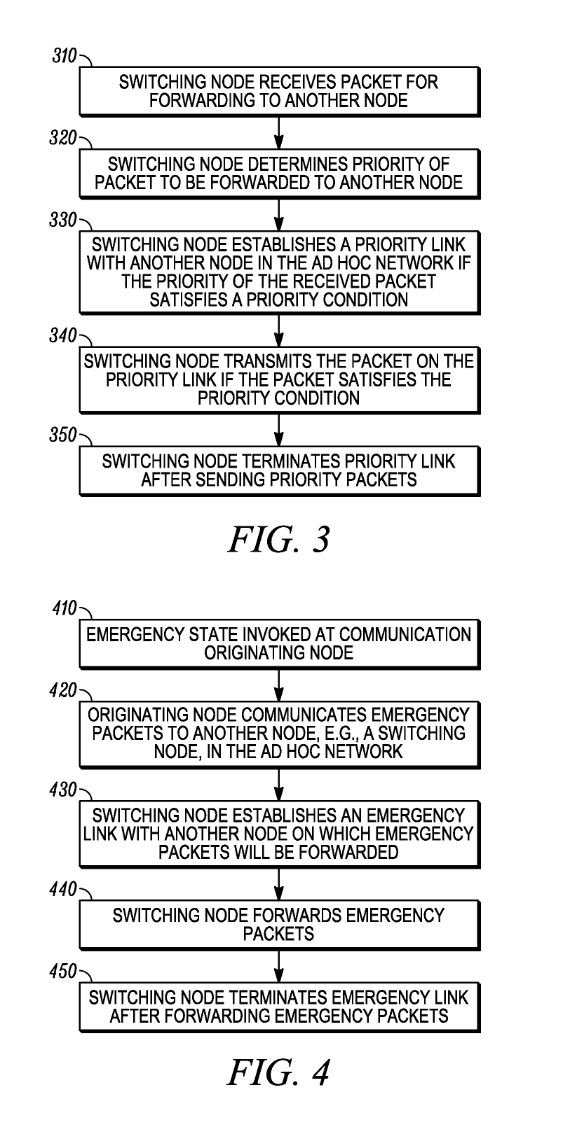

In instances where a node functions as a switching node forwarding packets received from one node to another node, the controller of the switching node is configured to forward a received packet to another node. The controller, for example, controller 220 in FIG. 2, is typically implemented as a programmable digital processor controlled by software and/or firmware. In the process flow diagram of FIG. 3, at 310, a switching node receives a packet for forwarding to another node. In FIG. 1, for example, node N₁ is a switching node that receives packets from nodes N₀ for forwarding to nodes N₂ and/or N₄.

According to one aspect of the disclosure, the controller is configured to determine the priority of packets received from one node before forwarding the packets to another node. In FIG. 3, at 320, the switching node determines the priority of packets received for forwarding the packet. In FIG. 2, at 222, the controller performs an incoming or received packet priority determination function. In one embodiment, the controller determines the priority of the received packet by reading priority information from a header portion of the packet. For example, the header portion may include a bit field for indicating packet priority. In one implementation, the bit is set, for example, to “1” or “0”, to indicate that a packet has a high priority. In another implementation, multiple bits may be set to indicate various degrees of priority. For example, a two bit field could be set to indicate four different priority levels. In other implementations, other mechanisms may be implemented to indicate packet priority along a priority spectrum, for example, to indicate one of several possible priority levels. In another embodiment, a beacon is used to indicate the priority of packets as discussed more fully below.

According to another aspect of the disclosure, the switching node controller is configured to establish a priority link in the ad hoc network if the priority of the packet received at the switching node satisfies a priority condition. In cognitive wireless communication device, the device is configured to establish communication links from spectrum allocated for cognitive radio access. In cognitive radio access applications, the priority link is established within spectrum allocated for cognitive radio access.

The priority condition may be satisfied, for example, if a high priority bit is set in the packet header. Alternatively, the condition may be satisfied based upon receipt of a beacon, for example, a cognitive access beacon, at the switching node wherein the beacon indicates that the packet is a high priority packet. In FIG. 2, at 224, the controller is configured to perform the priority link establishment function. In FIG. 3, at 330, the switching node establishes a priority link with another node in the ad hoc network based upon the priority of the packet. In one implementation, establishing a priority link involves establishing a dedicated portion of the available spectrum between the switching node and one or more neighboring nodes. In cognitive radio device implementations, establishing a priority link involves establishing a dedicated portion of the available spectrum allocated for cognitive radio access.

The controller is also preferably configured to automatically establish a new priority link or to re-designate or re-classify an existing link as a priority link if, due to the dynamic nature of ad hoc networks, the node or nodes with which the priority link was originally established leaves the network. In FIG. 1, for example, if a priority link established between nodes N₁ and N₂ is terminated because node N₂ departs the network, node N₁ may establish a new priority link with node N₄ or some other link.

In one embodiment, the controller of the wireless communication device establishes a new link designated as the priority link with one or more neighboring nodes. For example, the switching node may utilize an unused transceiver, if available, to establish a new link to another node, where the new link has a unique frequency and/or modulation format that has been determined to be available to both the switching node and the neighboring node by a cognitive access algorithm that dynamically monitors spectrum availability. According to this embodiment, packets that satisfy the priority condition are forwarded to the next switching node or to the destination node via the new priority link. In another embodiment, the priority link is established by designating an existing link as the priority link. An existing link may be designated as a priority link if a new link cannot be established, for example, due to a limited number of transceivers at the switching node or due to a limited availability of the number of adjacent or neighboring nodes. In some embodiments, the existing link designated as the priority link is assigned a new frequency and/or modulation format. According to this latter embodiment, non-priority packets may be transmitted on another existing link. Alternatively, for example, in the event that there is no other link on which the non-priority packets may be transmitted, the transmission of the non-priority packets may be delayed until transmission of the priority packets is complete.

The controller is also configured to cause the transceiver to transmit the received packet on the priority link, assuming that a condition associated with transmission on the priority link is satisfied. In FIG. 2, at 226, the controller 220 is configured to queue packets satisfying a priority condition in the buffer 230 for transmission on the priority link by the transceiver 210. In FIG. 3, at 340, the switching node transmits, or forwards, the packet on the priority link.

In one embodiment, after transmitting the priority packet or packets, for example, upon depletion of the priority packets in the buffer, the controller is configured to terminate the priority link. In FIG. 3, at 350, the switching node terminates the priority link after sending the priority packets. In FIG. 2, the controller is configured to perform the priority link termination function at 228. In cognitive radio access environments, the vacated spectrum used for the priority link is detectable and thus becomes available for a different allocation upon termination of the priority link. In embodiments where an existing link is designating as the priority link, the priority link reverts to its previous non-priority designation. In embodiments where the priority link is a newly created link, the priority link may be de-constructed or it may be re-designated as a non-priority link. In either case, the priority link may be reclassified by changing the frequency and/or the modulation format of the priority link re-designated as a non-priority link.

In some embodiments, the controller is configured to delay termination of the priority link after transmitting the last of the priority packets, for example, upon transmitting all priority packets in the switching node buffer. Thus if additional priority packets are received for forwarding to another node within the delay interval, it will be unnecessary to re-establish the priority link. Delaying termination of the priority link reduces unnecessary termination and re-establishment of the priority link, which may be inefficient. While a variety of schemes could be adopted to delay termination of the priority link and to determine the delay interval, the specific implementations of these schemes in ad hoc network environments are generally beyond the scope of this disclosure.

In an alternative embodiment, the switching node receives a beacon having a priority access indicator indicating packet priority. In one implementation, a tag or indicator indicating packet priority is added to the beacon defined by the 802.11(s) protocol specification. The 802.11(s) beacon is transmitted regularly and is typically used to aid the self-formation of mesh-capable nodes by specifying mesh capability and preferred channel use for neighbor mesh point (MP) links. The beacon is transmitted by the source or switching node before transmitting any high priority packets. The beacon would contain information describing the high priority packets. Such information may include, but is not limited to, source node identification, message IDs, destination information, or a combination of the above information. The switching node receiving the beacon will then record the high priority packet information contained in the beacon. All packets received by the node will then be compared to the recorded information to determine whether the packet is a priority packet.

Upon receiving a beacon and a high priority packet, the switching node receiving the beacon re-transmits the beacon ahead of the high priority packet to indicate the priority statues of the packet to other nodes. The beacon has information elements that together with a rule set allow the node or mesh points (MPs) to decide which channel in a multi-channel environment to use to link to other node or MPs in the mesh. According to this embodiment, the switching node controller is configured to prompt transmission of a beacon indicating the priority of the packet before causing the transmitter to transmit emergency or high priority packets on the priority link. The beacon is transmitted to the one or more neighboring nodes to which the priority packet will be transmitted. In FIG. 2, at 232, the controller is configured to control the configuration and transmission of beacons for indicating packet priority.

In one use case, a communication originating node enters a high priority packet transmission state or mode. In FIG. 1, for example, node N₀, assumes a high priority communication state. In one application, the originating node is operated by a public safety official intent on communicating emergency-related information over the ad hoc network. In FIG. 4, at 410, the high priority communication originating device enters a high priority communication mode. In this application, a public safety official may signal the emergency communication state by pressing an emergency button or by some other expedient means. More generally, however, the high priority communication state may be assumed by some other means, for example, via selection at a user interface of the communication device. In one embodiment, the emergency mode is communicated to one or more neighboring nodes via a beacon, as discussed above. The high priority or emergency status of the packets sent by the originating node may also be indicated by packet header information. In this embodiment, during the emergency state or mode, the header portion of each packet to be transmitted is modified to indicate the high priority or emergency status of the packets. Alternatively, the emergency status of the packets from the originating node may be indicated only by transmission of a beacon. The use of a beacon to indicate the priority of the packets generally does not require that the packet header have a priority indicator. In some embodiments, however, the packet header could be used to indicate packet priority in combination with the use of the beacon. For example, the beacon may reference the state of a priority field set in the packet header or indicate the presence of the field in the packet header.

In FIG. 4, at 420, the originating node communicates the high priority or emergency packets to another node in the ad hoc network. The other node may be the destination node or more generally it may be a switching node that forwards the packets to another node. In FIG. 1, for example, node N₀ invokes an emergency state and communicates emergency packets to node N₁. In FIG. 4, at 430, the switching node establishes an emergency link on which emergency packets will be forwarded. In FIG. 1, for the case where node N₁ functions as a switching node, the node N₁ establishes an emergency link with one or more other nodes. As discussed above, the emergency link may be a newly established link distinguished from existing links by frequency and/or modulation format. Alternatively, an existing link may be designated as the emergency link.

In FIG. 4, at 440, the switching node forwards emergency packets received from one node to another node on the emergency link. In FIG. 1, for example, the node N₁ establishes a high priority, or emergency, link with node N₂. The node N₁ then forwards emergency packets received from node N₀ to Node N₂. Other switching nodes linked between the originating node and the destination node will perform the same functions in terms of establishing an emergency link and forwarding emergency packets to another node. For example, switching node N₂ may establish an emergency link with node N₅ and forward the emergency packets to node N₅. For mesh network applications, one node, for example, node N₅, functions as a mesh access point (MAP) for connectivity to fixed infrastructure, for example, to the IP-based network 122 in FIG. 1. In FIG. 1, if the node N₂ drops out of the network, node N₁ may establish a new emergency link with node N₄, which may in turn establish a link with node N₅ either directly or via node N₃, thus maintaining the integrity of the high priority link. In FIG. 4, at 450, the emergency link is terminated after switching the emergency packets.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a cognitive wireless communication device operable in an ad hoc network, the method comprising:
receiving a packet that must be forwarded to another node;
determining a priority of the packet received;
establishing a priority link within spectrum allocated for cognitive radio access if the packet satisfies a priority condition;
transmitting the packet on the priority link established if the priority condition is satisfied.

2. The method of claim 1,
queuing packets satisfying the priority condition for transmission on the priority link,
terminating the priority link when the queue of packets satisfying the priority condition has been depleted.

3. The method of claim 1,
determining the priority of the packet by reading priority information from a header of the packet,
establishing the priority link if the priority information satisfies the priority condition.

4. The method of claim 1, establishing the priority link includes establishing a new link within spectrum allocated for cognitive radio access, the new link having a particular frequency and modulation.

5. The method of claim 1, establishing the priority link includes designating an existing link as the priority link.

6. The method of claim 5,
queuing packets satisfying the priority condition for transmission on the priority link,
terminating the priority link designation of the existing link when the queue of packets satisfying the priority condition has been depleted.

7. The method of claim 1,
receiving a beacon having a priority packet description,
determining the priority of the packet based upon the priority packet description,
establishing the priority link based upon the priority packet description.

8. The method of claim 7,
receiving a subsequent beacon devoid of a priority packet description,
eliminating the priority link in response to receiving the beacon devoid of the priority packet description.

9. The method of claim 7, transmitting a beacon indicating the priority of the packet before transmitting the packet.

10. The method of claim 1,
determining the priority of the packet by reading priority information from a header of the packet,
queuing the packet for transmission on the priority link based upon the priority information in the packet header, and
transmitting the packet on the priority link after queuing.

11. A wireless communication device operable as a node in an ad hoc network, the device comprising:
a transceiver;
a controller communicably coupled to the transceiver,
the controller configured to determine priority of a packet received by the transceiver for forwarding to another node in an ad hoc network,
the controller configured to establish a priority link in the ad hoc network if the priority of the packet satisfies a priority condition,
the controller configured to cause the transceiver to transmit the received packet on the priority link if the priority condition is satisfied.

12. The device of claim 11 is a cognitive wireless communication device configured to establish a communication link from spectrum allocated for cognitive radio access, wherein the priority link is established within the spectrum allocated for cognitive radio access.

13. The device of claim 11,
a buffer communicably coupled to the transceiver,
the controller configured to queue packets satisfying the priority condition in the buffer for transmission on the priority link by the transceiver,
the controller configured to terminate the priority link when the queue of packets satisfying the priority condition has been depleted.

14. The device of claim 11,
the controller configured to determine the priority of the packet by reading priority information from a header of the packet,
the controller configured to establish the priority link if the priority information satisfies the priority condition.

15. The device of claim 11, the controller configured to establish the priority link by establishing a new link having a particular frequency and modulation to another node in the ad hoc network.

16. The device of claim 11, the controller configured to establish the priority link by designating an existing link as the priority link.

17. The device of claim 16,
the controller configured to queue packets satisfying the priority condition for transmission on the priority link,
the controller configured to terminate the priority link designation of the existing link when the queue of packets satisfying the priority condition has been depleted.

18. The device of claim 11,
the controller configured to determine the priority of the packet based upon a priority access indicator in a beacon received by the transceiver,
the controller configured to establish the priority link based upon the priority access indicator.

19. The device of claim 17, the controller configured to prompt transmission of a beacon indicating the priority of the packet before causing the transmitter to transmit the packet on the priority link.

20. The device of claim 11,
the controller configured to determine the priority of the packet based upon priority information read from a header of the packet,
the controller configured to queue the packet for transmission on the priority link based upon the priority information in the packet header, and
the receiver configured to transmit the packet on the priority link after queuing.
